(19) United States
(12) Patent Application Publication
(10) Pub. No.: US 2020/0159759 A1
(43) Pub. Date: May 21, 2020

(54) SYSTEMS AND METHODS FOR INDEXING A CONTENT ASSET

(71) Applicant: Comcast Cable Communication, LLC, Philadelphia, PA (US)

(72) Inventor: Ehsan Younessian, Washington, DC (US)

(21) Appl. No.: 16/196,907

(22) Filed: Nov. 20, 2018

(51) Int. Cl. G06F 16/41; G06F 16/483; G06F 16/583

(52) U.S. Cl. CPC G06F 16/41; G06F 16/5854; G06F 16/5838; G06F 16/483

(57) ABSTRACT

Methods and systems are described for indexing a content asset (e.g., video, a program, a show, etc.). A plurality of keyframes may be generated for a portion of the content asset. Based on the plurality of keyframes, a number of attributes (e.g., a quantity of faces, objects, advertisements, etc.) of the portion of the content asset may be determined/identified. A segment label may be associated with the portion of the content asset based on the determined attributes.

### BACKGROUND

A content asset (e.g., video, a program, a show, etc.) may include several segments (e.g., portions, etc.). A content asset may include an opening monologue segment, an interview segment, and a performance segment, with one or more advertisements separating the respective segments. A user receiving (e.g., via a user device and/or a display) the content asset may wish to skip directly to a particular segment and/or skip over the one or more advertisements.

### SUMMARY

It is to be understood that both the following general description and the following detailed description are exemplary and explanatory only and are not restrictive. Methods and systems for indexing a content asset are described. A segment of a content asset (e.g., video, a program, a show, etc.) may be received. A plurality of keyframes may be extracted from the content asset. Using the plurality of keyframes, the segment of content asset may be indexed to identify a label for the segment of the content asset. A number of faces (e.g., actors' faces) may be determined for each of the plurality of keyframes. A segment label for the segment of the content asset may be determined based on a number of detected faces in the corresponding keyframes. Additionally, a segment label for the segment of content asset may be determined by applying an image classifier to the plurality of keyframes. The image classifier may use a supervised machine learning model. The image classifier may detect one or more objects in the plurality of keyframes. A segment label for the segment of the content asset may be determined based on which objects are detected in the corresponding keyframes. A segment profile may describe which objects are typically found in the keyframes of a given segment. A segment profile identifying objects most similar to the objects detected by the image classifier may be selected. The segment of the content asset corresponding to the respective keyframes may be assigned a segment label in the selected segment profile.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, together with the description, serve to explain the principles of the methods and systems:

FIG. 1 is an example content distribution network;

FIG. 2 is an example segment profile list;

FIG. 3 is a flowchart of a method for indexing a content asset;

FIG. 4 is a flowchart of a method for indexing a content asset;

FIG. 5 is a flowchart of a method for indexing a content asset; and

FIG. 6 is a block diagram of an example computing device.

### DETAILED DESCRIPTION

Before the present methods and systems are described, it is to be understood that the methods and systems are not limited to specific methods, specific components, or to particular implementations. It is also to be understood that the terminology used herein is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another range includes from the one particular value and/or to the other particular value. Similarly, when values are expressed as approximations, by use of the antecedent “about,” it will be understood that the particular value forms another value or range. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Such as” is not used in a restrictive sense, but for explanatory purposes.

Disclosed are components that may be used to perform the described methods and systems. These and other components are described herein, and it is understood that when combinations, subsets, interactions, groups, etc. of these components are described that while specific reference of each various individual and collective combinations and permutation of these may not be explicitly described, each is specifically contemplated and described herein, for all methods and systems. This applies to all parts of this application including, but not limited to, steps in described methods. Thus, if there are a variety of additional steps that may be performed, it is understood that each of these additional steps may be performed with any combination or permutation of the described methods.

The present methods and systems may be understood more readily by reference to the following detailed description and to the Figures and their previous and following description.

As will be appreciated by one skilled in the art, the methods and systems may be entirely hardware, entirely software, or a combination of software and hardware. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

The methods and systems are described below with reference to block diagrams and flowcharts of methods, systems, apparatuses and computer program products. It will be understood that each block of the block diagrams and flowcharts, and combinations of blocks in the block diagrams and flowcharts, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowcharts support combinations of means for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

Content items (which may also be referred to as “content,” “content data,” “content information,” “content asset,” “multimedia asset data file,” or simply “data” or “information”) may be any information or data that may be licensed to one or more individuals (or other entities, such as business or group) and may be electronic representations of video, audio, text and/or graphics, which may be but are not limited to electronic representations of videos, movies, or other multimedia, which may be but is not limited to data files adhering to MPEG2, MPEG, MPEG4 UHD, HDR, 4k, Adobe® Flash® Video (.FLV) format or some other video file format whether such format is presently known or developed in the future. The content items described herein may be electronic representations of music, spoken words, or other audio, which may be but is not limited to data files adhering to the MPEG-1 Audio Layer 3 (.MP3) format, Adobe®, CableLabs 1.0,1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (.EPUB) format created by the International Digital Publishing Forum (IDPF), JPEG (.7PG) format, Portable Network Graphics (.PNG) format, dynamic ad insertion data (.csv), Adobe® Photoshop® (.PSD) format or some other format for electronically storing text, graphics and/or other information whether such format is presently known or developed in the future. Content items may be any combination of the above-described formats.

Phrases used herein, such as “accessing” content, “providing” content, “viewing” content, “listening” to content, “rendering” content, “playing” content, “consuming” content, and the like are considered interchangeable, related, and/or the same. In some cases, the particular term utilized may be dependent on the context in which it is used. Accessing video may also be referred to as viewing or playing the video. Accessing audio may also be referred to as listening to or playing the audio.

This detailed description may refer to a given entity performing some action. It should be understood that this language may in some cases mean that a system (e.g., a computer) owned and/or controlled by the given entity is actually performing the action.

A content asset (e.g., video, a program, a show, etc.) may include a plurality of segments (e.g., portions, etc.), such as an opening monologue segment, an interview segment, a performance segment, and/or the like. A content asset may include any type of segments (e.g., portions, etc.). Segments of the plurality of segments may be separated by one or more advertisements. A segment of a plurality of segments of a content asset may be indexed by assigning a label to the respective segment. Metadata associated with the content asset (e.g., video, a program, a show, etc.) may identify one or more segments (e.g., one or more time codes or cues demarking a particular segment) of the plurality of segments and the corresponding labels. The metadata may be provided and/or sent to a user via a program guide and/or user interface. The metadata may enable a user to easily navigate to a particular segment of the content asset. A user accessing the content asset, such as via a user device and/or display, may desire and/or intend to bypass the advertisements of content asset. The user may select for access (e.g., display) a segment of the plurality of segments that immediately follows advertisement of the one or more advertisements (e.g., an advertisement break, etc.). A user accessing the content asset, such as via a user device and/or display, may desire and/or intend to only access a particular segment of the content asset may select a segment of the plurality of segments that they desire and/or intend to access.

To index a segment of content asset, a plurality of keyframes may be determined (e.g., extracted, analyzed, accessed, stored, etc.) from the content asset. Using the plurality of keyframes, the content asset one or more segments of the content asset may be identified. A number of faces or partial faces (e.g., actors' faces) may be determined for each of the plurality of keyframes. A segment label for particular segment of the content asset may be determined based on a number of detected faces in the corresponding keyframes. For a talk show, detecting a single face may indicate a monologue segment, detecting two faces may indicate an interview segment, and detecting two or more faces may indicate a musical performance segment. Detecting zero faces may indicate an advertisement.

A segment label for a particular segment may be determined by applying an image classifier to the plurality of keyframes. The image classifier may use a supervised machine learning model. The image classifier may detect one or more objects in the plurality of keyframes. A segment label for a particular segment of the content asset may be determined based on which objects are detected in the corresponding keyframes. For a talk show, detecting objects such as a “curtain,” a “stage,” and a “suit” may indicate a monologue segment. Detecting a “couch” and/or a “coffee mug” may indicate an interview segment. Detecting a “stage,” and one or more musical instruments (e.g., “drums,” a “guitar,”) may indicate a musical performance segment.

A segment profile may describe which objects are typically found in the keyframes of a given segment. The objects may be identified in the segment profile as a list, as natural language text, or otherwise identified. The segment profile may also indicate a number of faces typically found in the particular segment. A segment profile for the interview segment may be the natural language text “One man in a suit in front of a curtain.” Thus, the monologue segment may be identified by identifying key frames corresponding to one face and an identified suit and curtain. A segment profile identifying objects most similar to the objects detected by the image classifier may be selected. The segment label for the particular segment may be determined as a segment label indicated in the selected segment profile.

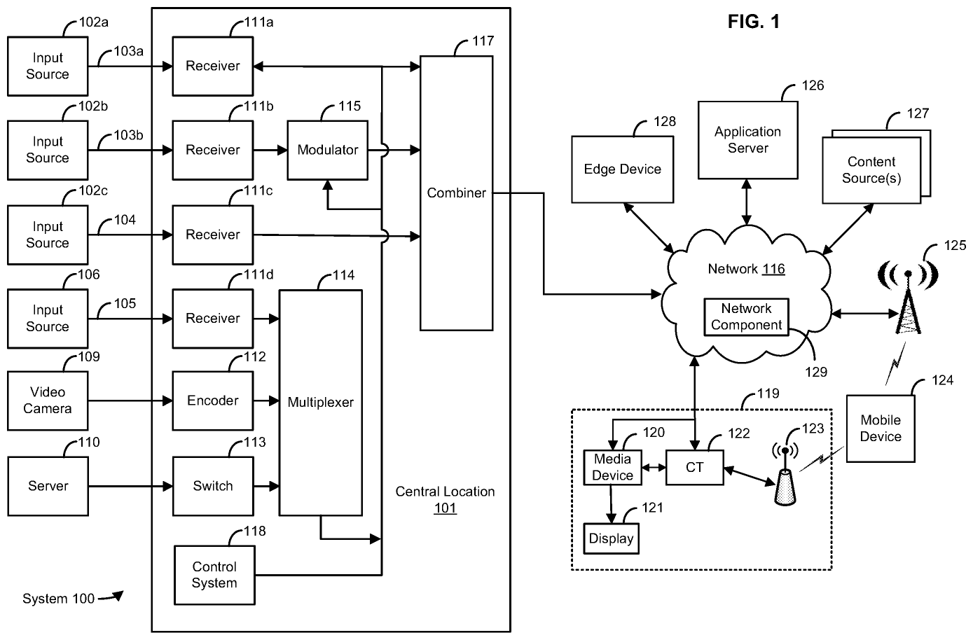

FIG. 1 shows a system in which the present methods and systems may operate.

Those skilled in the art will appreciate that present methods may be used in systems that employ both digital and analog equipment. One skilled in the art will appreciate that provided herein is a functional description and that the respective functions may be performed by software, hardware, or a combination of software and hardware.

A system 100 may have a central location 101 (e.g., a headend), which may receive content (e.g., data, input programming, and the like) from multiple sources. The central location 101 may combine the content from the various sources and may distribute the content to user (e.g., subscriber) locations (e.g., location 119) via a distribution system 116.

The central location 101 may receive content from a variety of sources 102a, 102b, 102c. The content may be sent from the source to the central location 101 via a variety of transmission paths, including wireless (e.g. satellite paths 103a, 103b) and a terrestrial path 104. The central location 101 may also receive content from a direct feed source 106 via a direct line 105. Other input sources may be capture devices such as a video camera 109 or a server 110. The signals provided by the content sources may be a single content item or a multiplex that has several content items.

The central location 101 may be one or a plurality of receivers 111a, 111b, 111c, 111d that are each associated with an input source. MPEG encoders, such as an encoder 112, are used for encoding local content or a video camera 109 feed. A switch 113 may provide access to the server 110, which may be a Pay-Per-View server, a data server, an internet router, a network system, a phone system, and the like. Some signals may require additional processing, such as signal multiplexing, prior to being modulated. Such multiplexing may be performed by a multiplexer (mux) 114.

The central location 101 may be one or a plurality of modulators 115 for interfacing to a network 116. The modulators 115 may convert the received content into a modulated output signal suitable for transmission over a network 116. The output signals from the modulators 115 may be combined, using equipment such as a combiner 117, for input into the network 116. The network 116 may be a content delivery network, a content access network, and/or the like. The network 116 may be configured to provide content from a variety of sources using a variety of network paths, protocols, devices, and/or the like. The content delivery network and/or content access network may be managed (e.g., deployed, serviced) by a content provider, a service provider, and/or the like.

A control system 118 may permit a system operator to control and monitor the functions and performance of the system 100. The control system 118 may interface, monitor, and/or control a variety of functions, including, but not limited to, the channel lineup for the television system, billing for each user, conditional access for content distributed to users, and the like. The control system 118 may provide input to the modulators for setting operating parameters, such as system specific MPEG table packet organization or conditional access information. The control system 118 may be located at the central location 101 or at a remote location.

The network 116 may distribute signals from the central location 101 to user locations, such as a user location 119. The network 116 may be an optical fiber network, a coaxial cable network, a hybrid fiber-coaxial network, a wireless network, a satellite system, a direct broadcast system, an Ethernet network, a high-definition multimedia interface network, universal serial bus network, or any combination thereof.

A multitude of users may be connected to the network 116 at one or more of the user locations. At the user location 119, a media device 120 may demodulate and/or decode, if needed, the signals for display on a display device 121, such as on a television set (TV) or a computer monitor. The media device 120 may be a demodulator, decoder, frequency tuner, and/or the like. The media device 120 may be directly connected to the network (e.g., for communications via in-band and/or out-of-band signals of a content delivery network) and/or connected to the network 116 via a communication terminal 122 (e.g., for communications via a packet switched network). The media device 120 may be a set-top box, a digital streaming device, a gaming device, a media storage device, a digital recording device, a combination thereof, and/or the like. The media device 120 may be one or more applications, such as content viewers, social media applications, news applications, gaming applications, content stores, electronic program guides, and/or the like. Those skilled in the art will appreciate that the signal may be demodulated and/or decoded in a variety of equipment, including the communication terminal 122, a computer, a TV, a monitor, or satellite dish.

The communication terminal 122 may be located at the user location 119. The communication terminal 122 may be configured to communicate with the network 116. The communications terminal 122 may be a modem (e.g., cable modem), a router, a gateway, a switch, a network terminal (e.g., optical network unit), and/or the like. The communications terminal 122 may be configured for communication with the network 116 via a variety of protocols, such as internet protocol, transmission control protocol, file transfer protocol, session initiation protocol, voice over internet protocol, and/or the like. For a cable network, the communication terminal 122 may be configured to provide network access via a variety of communication protocols and standards, such as Data Over Cable Service Interface Specification.

The user location 119 may be a first access point 123, such as a wireless access point. The first access point 123 may be configured to provide one or more wireless networks in at least a portion of the user location 119. The first access point 123 may be configured to provide access to the network 116 to devices configured with a compatible wireless radio, such as a mobile device 124, the media device 120, the display device 121, or other computing devices (e.g., laptops, sensor devices, security devices). The first access point 123 may provide a user managed network (e.g., local area network), a service provider managed network (e.g., public network for users of the service provider), and/or the like. It should be noted that in some configurations, some or all of the first access point 123, the communication terminal 122, the media device 120, and the display device 121 may be implemented as a single device.

The user location 119 may not be fixed. A user may receive content from the network 116 on the mobile device 124. The mobile device 124 may be a laptop computer, a tablet device, a computer station, a personal data assistant (PDA), a smart device (e.g., smart phone, smart apparel, smart watch, smart glasses), GPS, a vehicle entertainment system, a portable media player, a combination thereof, and/or the like. The mobile device 124 may communicate with a variety of access points (e.g., at different times and locations or simultaneously if within range of multiple access points). The mobile device 124 may communicate with a second access point 125. The second access point 125 may be a cell tower, a wireless hotspot, another mobile device, and/or other remote access point. The second access point 125 may be within range of the user location 119 or remote from the user location 119. The second access point 125 may be located along a travel route, within a business or residence, or other useful locations (e.g., travel stop, city center, park).

The system 100 may be an application device 126. The application device 126 may be a computing device, such as a server. The application device 126 may provide services related to applications. The application device 126 may be an application store. The application store may be configured to allow users to purchase, download, install, upgrade, and/or otherwise manage applications. The application device 126 may be configured to allow users to download applications to a device, such as the mobile device 124, communications terminal 122, the media device 120, the display device 121, and/or the like. The application device 126 may run one or more application services to provide data, handle requests, and/or otherwise facilitate operation of applications for the user.

The system 100 may be one or more content source(s) 127. The content source(s) 127 may be configured to provide content (e.g., video, audio, games, applications, data) to the user. The content source(s) 127 may be configured to provide streaming media, such as on-demand content (e.g., video on-demand), content recordings, and/or the like. The content source(s) 127 may be managed by third party content providers, service providers, online content providers, over-the-top content providers, and/or the like. The content may be provided via a subscription, by individual item purchase or rental, and/or the like. The content source(s) 127 may be configured to provide the content via a packet switched network path, such as via an internet protocol (IP) based connection. The content may be accessed by users via applications, such as mobile applications, television applications, set-top box applications, gaming device applications, and/or the like. An application may be a custom application (e.g., by content provider, for a specific device), a general content browser (e.g., web browser), an electronic program guide, and/or the like.

The system 100 may be an edge device 128. The edge device 128 may be configured to provide content, services, and/or the like to the user location 119. The edge device 128 may be one of a plurality of edge devices distributed across the network 116. The edge device 128 may be located in a region proximate to the user location 119. A request for content from the user may be directed to the edge device 128 (e.g., due to the location of the edge device and/or network conditions). The edge device 128 may be configured to package content for delivery to the user (e.g., in a specific format requested by a user device), provide the user a manifest file (e.g., or other index file describing segments of the content), provide streaming content (e.g., unicast, multicast), provide a file transfer, and/or the like. The edge device 128 may cache or otherwise store content (e.g., frequently requested content) to enable faster delivery of content to users.

The network 116 may be a network component 129. The network component 129 may be any device, module, and/or the like communicatively coupled to the network 116. The network component 129 may be a router, a switch, a splitter, a packager, a gateway, a encoder, a storage device, a multiplexer, a network access location (e.g., tap), physical link, and/or the like.

The central location 101 may receive a content asset (e.g., video, a program, a show, etc.). The content asset may include a plurality of segments, and the central location 101 may receive a segment of the plurality of segments of the content asset. The central location 101 may then generate a plurality of keyframes from the segment of the content asset. A keyframe (intra-frame) may be a single frame of a content asset that is encoded independent of frames that precede and follow it. A keyframe may store all of the data needed to display the frame. A keyframe (intra-frame) may include a frame of a content asset (e.g., a frame of video) that is compressed/encoded without reference to one or more other frames of the plurality of frames, such as a predictive coded frame (“P-frame) or a bi-directionally predictive coded (“B-frame”). A P-frame may include a frame of the content asset encoded with reference to another frame, such as the keyframe. A B-frame may include a frame of the content asset encoded with reference to multiple frames. A scene of the segment of the content asset (e.g., video, program, show, etc.) may include a plurality of keyframes, P-frames, and B-frames. To determine the plurality of keyframes, a plurality of scenes (e.g., shots, etc.) of the segment of the content asset may be determined. A scene of the segment of the content asset (e.g., video, program, show, etc.) may be a quantity/amount of the content asset (e.g., a plurality of frames, etc.) recorded and/or rendered from a particular visual perspective (e.g., from a particular camera). A keyframe for a given scene may be determined to be and/or identified as a median frame of the scene (e.g., plurality of frames, etc.), a randomly selected frame of the scene, or otherwise determined/identified.

A number of faces may be identified for each keyframe of the plurality of keyframes. A facial recognition algorithm may be applied to identify a number of faces in a given keyframe. The facial recognition algorithm may also identify whose face(s) are in the given keyframe. A number of faces for a segment of the content asset (e.g., video, program, show, etc.) may be determined as an aggregate of a number of faces determined for each of the keyframes of the segment of the content asset. The aggregate may be an average, a median, a logarithmic function, or other aggregate function.

One or more objects may also be identified in each keyframe. An object may be any physical object or item in a given keyframe, (e.g., a “couch,” a “table,” a “desk,” a “meatloaf,” etc.). An image classifier may be applied to a given keyframe to identify the objects in the given keyframe. The image classifier may use a machine learning model. The image classifier may use a supervised machine learning model (e.g., a convolutional neural network (CNN), a deep neural network (DNN)) or an unsupervised machine learning model (e.g., a clustering algorithm, a general adversarial network (GAN)). Where the image classifier is a supervised machine learning model, the image classifier may be trained. One or more objects may be identified for a segment of the content asset (e.g., video, program, show, etc.) as an aggregate of the one or more objects determined for each of the keyframes of the segment of the content asset. The aggregate may be an average, a median, a logarithmic function, or other aggregate function.

Determining the one or more objects (e.g., for a keyframe or a segment of a content asset) may be achieved by filtering the one or more objects from the final set of identified objects. An object may be filtered from the one or more objects based on a number of keyframes in which the object appears. An object may be filtered if it appears in a number of keyframes falling below a threshold. The threshold may be a predefined threshold (e.g., two keyframes, five keyframes), a percentage of keyframes (e.g., five percent of keyframes for the segment, twenty percent of keyframes for the segment), or otherwise defined. An object may also be filtered if a confidence score for the object generated by the image classifier falls below a threshold. The one or more objects may be filtered by selecting N objects from the one or more objects having a highest confidence score or appearing in a highest number of keyframes.

The identified number of faces and/or the identified objects for a given segment of a content asset (e.g., video, program, show, etc.) may be encoded in a multidimensional data structure (e.g., a list, an array, a vector). Assuming an image classifier capable of identifying N different objects, an N-dimensional data structure may be generated for a given segment. Each dimension of the data structure may encode a confidence score indicating a confidence of the image classifier that a corresponding object is within the given content asset. The confidence score may be weighted. The weight for each confidence score may be based on how many times the corresponding object appears in a segment. The data structure may also have a dimension encoding a number of faces in the given segment of the content asset, thereby resulting in an N+1 dimensional data structure.

A multidimensional data structure “segRep” may be expressed as:
segRep=[O1, O2, O3, . . . , O1000, FF], where
Oi=freq(object_i,KF_seg)/log(freq(object_i, KF_all)); freq(object_i, KF_seg): number of times the object_i appears in the segment's keyframes (i.e. KF_seg), KF_all: all keyframes accessible to the image classifier
FF=median({FF_i}) i=1,2, . . . , n; FF_i is the facial feature of the ith keyframe in the segment. n is the total number of keyframes in the segment. FF_i: number of faces+faceLoc/10̂(number of faces); faceLoc=int(str([location_k])), k=1,2, 3, . . . , number_of_faces. location_k: the hashed location of the kth face.

A segment label may be determined for the segment of the content asset (e.g., video, program, show, etc.). The segment label may be an identifier or descriptor of the segment of the content asset. Where the segment of the content asset is an interview segment of a talk show, the segment label may be the text string “interview.” Where the segment of the content asset is and/or includes an advertisement, the segment label may be the text string “advertisement.”

The segment label may be determined based on the determined number of faces for the segment of the content asset (e.g., video, program, show, etc.). A segment of the content asset having one face may be identified as a “monologue” segment, thereby having the segment label “monologue.” A segment of the content asset with three or more faces may be identified as a “musical performance” segment, thereby having the segment label “musical performance.” A segment of the content asset with zero faces (e.g., does not include a face) may be identified as an “advertisement” segment, thereby having the segment label “advertisement.”

The segment label may also be determined based on the one or more objects identified for the segment of the content asset (e.g., as a function of the one or more objects identified for each keyframe of the content asset). A segment including an identified “suit,” “curtain,” and “stage” may be determined as a “monologue” segment, thereby having the segment label “monologue.” A segment including an identified “car” and “road” may be identified as an “advertisement” segment, thereby having the segment label “advertisement.”

The segment label may also be determined based on a time code of the segment of the content asset (e.g., video, program, show, etc.), such as where in the content asset the segment occurs. A first segment of the content asset and a second segment of the content asset may have one face identified. Assuming the first segment occurs within a time range for the beginning of the show (e.g., 0:00-10:00), the first segment may be identified as a “monologue.” Assuming the second segment occurs within a time range for the end of the show (e.g., 45:00-60:00), the second segment may be identified as a “musical performance.”

The segment label may be determined based on a segment profile. A segment profile identify a segment label and one or more attributes indicative of the particular segment. The one or more attributes may be a number of faces and/or one or more objects typically found in a particular segment. A segment profile for an “interview” segment may identify “two” faces, and the objects “desk,” “coffee mug,” “microphone,” and/or “couch.” The objects of a particular segment may be identified as a list. Both the number of faces and/or the objects of a particular segment may be identified as natural language text. Continuing with the segment profile for the “interview” segment, the segment profile may be the natural language description “two people talking at a couch and a desk with a coffee mug and microphone on it.” The segment profile may also identify a time range during which the segment typically occurs. A segment profile for a “monologue” segment may identify a time range for the beginning of the show (e.g., 0:00-10:00).

Accordingly, determining a segment label may be determining a segment profile of a plurality of segment profiles. A segment profile may be determined from the plurality of segment profiles as having a highest degree of similarity to the determined number of faces, identified one or more objects and/or time code of the segment of the content asset (e.g., video, program, show, etc.). The degree of similarity may be a cosine similarity or another degree of similarity. The identified objects and/or determined number of faces for the segment of the content asset may be encoded as a multidimensional data structure. A plurality of multidimensional data structures may be generated for the plurality of segment profiles to encode the number of faces and/or objects identified in each of the segment profiles. Where a segment profile is a natural language text description, generating a multidimensional data structure for the segment profile may be achieved by performing natural language processing and/or keyword identification to find one or more keywords corresponding to the one or more objects identifiable by the image classifier.

A segment profile may be determined as having a multidimensional data structure having a highest degree of similarity to the multidimensional data structure of the segment of the content asset (e.g., video, program, show, etc.). Having determined a segment profile, a segment label may be determined for the segment of the content asset as the segment label identified in the segment profile. Metadata may then be generated associating the segment label with the segment of the content asset. The metadata may associate the segment label with the segment of the content asset, by associating the segment label with a unique identifier for the segment of the content asset, a time code of where the segment of the content asset occurs, or other identifying data. The metadata may be a manifest or other type of metadata.

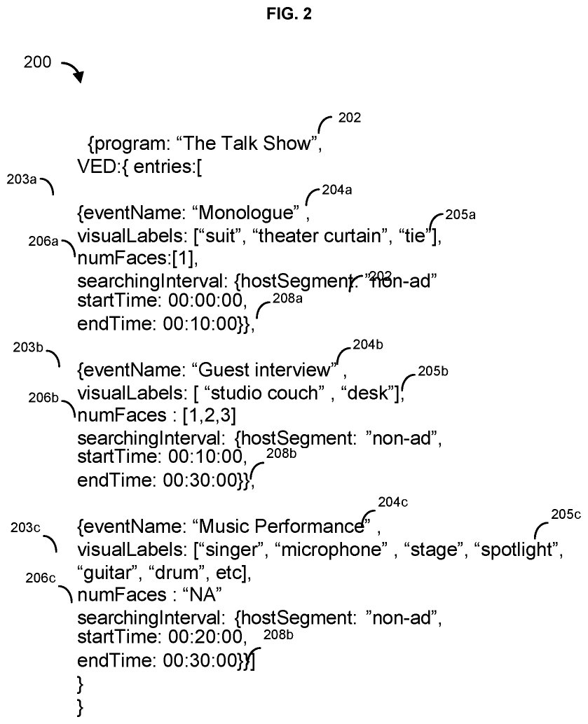

FIG. 2 is a segment profile list 200. The segment profile list 200 may have a program identifier 200, indicating that this segment profile list 200 is applicable to content assets (e.g., video, programs, shows, etc.) for episodes of “The Talk Show.” Included in the segment profile list 200 are segment profiles 203a, 203b, and 203c, each corresponding to a particular segment of “The Talk Show.” Segment profile 203a corresponds to a “Monologue” segment, as indicated by segment label 204a. Segment profile 203b corresponds to a “Guest interview” segment, as indicated by segment label 204b. Segment profile 203c corresponds to a “Music Performance” segment, as indicated by segment label 204c. Each segment profile 203a,b,c may have an object list 205a,b,c indicating a list of objects typically found in the corresponding segment and identifiable by an image classifier. Each segment profile 203a,b,c may also have a faces attribute 208a,b,c indicating a number of faces typically found in the corresponding segment. Faces attribute 206a indicates that one face is typically found in the “Monologue” segment. Faces attribute 206b indicates that one, two, or three faces are typically found in the “Guest interview” segment. Faces attribute 206c indicates that no particular number of faces is typically found in the “Music Performance” segment, as the segment may be a solo artist or a varying number of musicians. Each segment profile 203a,b,c further may have a time range 208a,b,c indicating a time in the content asset during which the particular segment typically occurs.

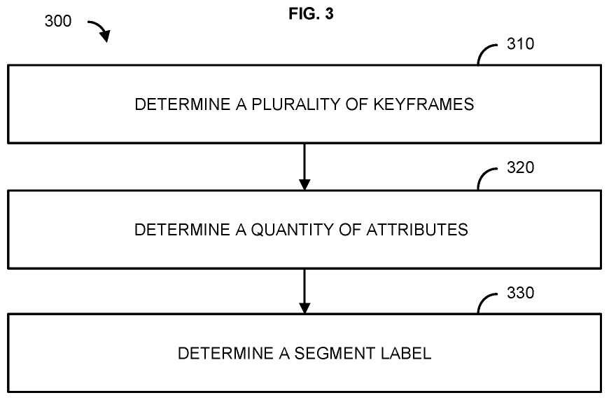

FIG. 3 is a flowchart 300 of a method. At step 310, a plurality of keyframes of a segment (e.g., portion, etc.) of a content asset (e.g., video, a program, a show, etc.) may be determined (e.g., extracted, generated, etc.) (e.g., by the central location). A keyframe may be a selected frame of the segment of the content asset. To determine the plurality of keyframes, a plurality of scenes (e.g., shots, etc.) of the segment of the content asset may be determined. A scene of the segment of the content asset (e.g., video, program, show, etc.) may be a quantity/amount of the content asset (e.g., a plurality of frames, etc.) recorded and/or rendered from a particular visual perspective (e.g., from a particular camera). A keyframe for a given scene may be determined to be and/or identified as a median frame of the scene (e.g., plurality of frames, etc.), a randomly selected frame of the scene, or otherwise determined/identified.

In some cases, each keyframe of the plurality of keyframes may be determined based on a quantity of changes between a previous frame of a plurality of frames of a segment (e.g., portion, etc.) of the content asset (e.g., video, a program, a show, etc.), a current frame of the plurality of frames, and a consecutive frame of the plurality of frames satisfying a threshold. When the quantity of changes satisfies the threshold, it may be determined that the current frame is a keyframe of the plurality of keyframes. In some cases, each keyframe of the plurality of keyframes may be determined based on an evaluation of color histograms. A color histogram may be determined for each frame of a plurality of frames of the content asset. Frames of the plurality of frames of the content asset with a color histogram of that include a distribution of color that satisfies a threshold may be a keyframe of the plurality of keyframes.

At step 330, a quantity of attributes of the plurality of keyframes may be determined. An attribute may be a quantity of faces within a given keyframe. A corresponding number of faces may be determined for each keyframe of the plurality of keyframes (e.g., by the central location 101). A facial recognition algorithm may be applied to identify a quantity/number of faces in a given keyframe. The facial recognition algorithm may also identify a face(s) that is part of the given keyframe. In some cases, attributes may also include objects, advertisements, and/or the like. An object identification algorithm may be used to determine/identify an object(s) within a keyframe. Metedata may be used to determine an advertisement(s) within a keyframe. Attributes of a keyframe may be determine by any method.

At step 340, a segment label may be determined for the segment of the content asset (e.g., video, program, show, etc.). The segment label may be determined based on the quantity of attributes satisfying an attribute threshold. In some cases, the segment label may be determined based on the corresponding number of faces for each of the plurality of keyframes satisfying the attribute threshold. The segment label may be an identifier or descriptor of the segment of the content asset. Where the segment of the content asset is an interview segment of a talk show, the segment label may be the text string “interview.” Where the segment of the content asset is an advertisement, the segment label may be the text string “advertisement.” In some cases, the segment label may be determined based on a quantity of objects within the segment of the content asset satisfying the attribute threshold. In some cases, the segment label may be determined based on a quantity of advertisements within the segment of the content asset satisfying the attribute threshold.

A quantity/number of faces for the segment of the content asset (e.g., video, program, show, etc.) may be determined as a function of the corresponding quantity/number of faces for each of the plurality of keyframes. The quantity/number of faces for the segment of the content asset may be an average, a median, a logarithmic function, or other function of the corresponding quantity/number of faces for each of the plurality of keyframes. The segment label may then be determined based on the quantity/number of faces for the segment of the content asset, such as by the quantity/number of faces satisfying the attribute threshold.

The segment label may be determined based on the determined number of faces for the segment of the content asset (e.g., video, program, show, etc.). A segment of the content asset having one face may be identified as a “monologue” segment (e.g., the attribute threshold may be satisfied by one face), thereby having the segment label “monologue.” A segment of the content asset having three or more faces may be identified as a “musical performance” segment, thereby having the segment label “musical performance.” A segment of the content asset having zero faces may be identified as an “advertisement” segment, thereby having the segment label “advertisement.”

The segment label may be determined based on a determined number of objects for the segment of the content asset (e.g., video, program, show, etc.). An object identification algorithm and/or an image classifier may be used to determine objects from the segment of the content asset. A segment of the content asset having an object identified as a stage and/or one or more objects identified as microphones may be identified as a “musical performance” segment, thereby having the segment label “musical performance.”

The segment label may be determined based on a time code of the segment of the content asset, e.g., where in the content asset the segment occurs. A first segment of the content asset (e.g., video content) and a second segment of the content asset may have one face identified. Assuming the first segment occurs within a time range for the beginning of the show (e.g., 0:00-10:00), the first segment may be identified as a “monologue.” Assuming the second segment occurs within a time range for the end of the show (e.g., 45:00-60:00), the second segment may be identified as a “musical performance.”

The segment label may be determined based on audio content and/or closed caption information of the segment of the content asset (e.g., video, program, show, etc.). Speech-to-text or any other approach may be used to convert one or more spoken words into one or more keywords or text strings. The segment label may then be determined based on the one or more keywords or text strings. Metadata associated with keyframes may indicate closed captioning information. The segment label may be determined based on the closed captioning information. A segment of the content asset having audio content or closed captioning information indicative of an interview may be identified as a “guest interview” segment, thereby having the segment label “interview.”

The segment label may be determined based on a segment profile. A segment profile may identify a segment label and one or more attributes indicative of the particular segment. The one or more attributes may include a number of faces typically found in a particular segment. A segment profile for an “interview” segment may identify “two” faces, or a list of “one, two, or three” faces. The segment profile may also identify a time range during which the segment typically occurs. A segment profile for a “monologue” segment may identify a time range for the beginning of the show (e.g., 0:00-10:00). The segment profile may also identify one or more keywords associated with audio content or closed captioning of the content asset.

Accordingly, determining a segment label may comprise determining a segment profile of a plurality of segment profiles. A segment profile may be determined from the plurality of segment profiles as having a highest degree of similarity to the determined number of faces. The degree of similarity may comprise a cosine similarity or another degree of similarity. Having determined a segment profile, a segment label may be determined for the segment of the content asset as the segment label identified in the segment profile. Metadata may then be generated associating the segment label with the segment of the content asset. The metadata may associate the segment label with the segment of the content asset, by associating the segment label with a unique identifier for the segment of the content asset, a time code of where the segment of the content asset occurs, or other identifying data. The metadata may include a manifest or other type of metadata.

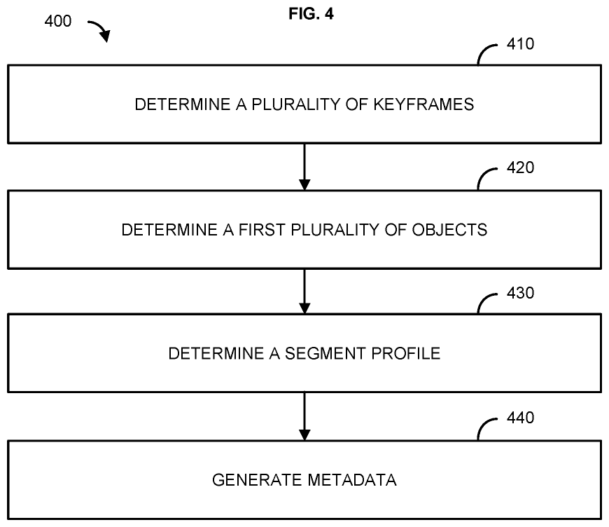

FIG. 4 is a flowchart 400 of a method. At step 410, a plurality of keyframes may be determined from a segment (e.g., portion) of a content asset (e.g., by a central location 101). A keyframe may be a selected frame of the segment of the content asset (e.g., video, program, show, etc.). To determine the plurality of keyframes, a plurality of scenes (e.g., shots, etc.) of the segment of the content asset may be determined. A scene of the segment of the content asset (e.g., video, program, show, etc.) may be a quantity/amount of the content asset (e.g., a plurality of frames, etc.) recorded and/or rendered from a particular visual perspective (e.g., from a particular camera). A keyframe for a given scene may be determined to be and/or identified as a median frame of the scene (e.g., plurality of frames, etc.), a randomly selected frame of the scene, or otherwise determined/identified.

In some cases, each keyframe of the plurality of keyframes may be determined based on a quantity of changes between a previous frame of a plurality of frames of a segment (e.g., portion, etc.) of the content asset (e.g., video, a program, a show, etc.), a current frame of the plurality of frames, and a consecutive frame of the plurality of frames satisfying a threshold. When the quantity of changes satisfies the threshold, it may be determined that the current frame is a keyframe of the plurality of keyframes. In some cases, each keyframe of the plurality of keyframes may be determined based on an evaluation of color histograms. A color histogram may be determined for each frame of a plurality of frames of the content asset. Frames of the plurality of frames of the content asset with a color histogram of that include a distribution of color that satisfies a threshold may be a keyframe of the plurality of keyframes.

At step 420, a first plurality of objects in the segment of the content asset (e.g., video, program, show, etc.) may be determined based on the plurality of keyframes (e.g., by the central location 101). An object may be any physical object or item in a given keyframe, (e.g., a “couch,” a “table,” a “desk,” a “meatloaf,” etc.). An image classifier may be applied to a given keyframe to identify the objects within in the given keyframe. The image classifier may use a machine learning model. The image classifier may use a supervised machine learning model (e.g., a convolutional neural network (CNN), a deep neural network (DNN)) or an unsupervised machine learning model (e.g., a clustering algorithm, a general adversarial network (GAN)). Where the image classifier is a supervised machine learning model, the image classifier may be trained. Thus, the first plurality of objects for the segment of the content asset may be determined as an aggregate of the one or more objects determined for each of the keyframes of the segment of the content asset. The aggregate may be an average, a median, a logarithmic function, or other aggregate function.

Determining the first plurality of objects may be achieved by filtering one or more objects from the first plurality of objects. An object may be filtered from the plurality of objects based on a number of keyframes (e.g., successive keyframes) in which the object appears. An object may be filtered if it appears in a number of keyframes falling below a threshold. The threshold may be a predefined threshold (e.g., two keyframes, five keyframes), a percentage of keyframes (e.g., five percent of keyframes for the segment, twenty percent of keyframes for the segment), or otherwise defined. An object may also be filtered if a confidence score for the object generated by the image classifier falls below a threshold. The first plurality of objects may be filtered by selecting, as the first plurality of objects, N objects a highest confidence score from the image classifier or appearing in a highest number of keyframes.

The first plurality of objects in the segment of the content asset (e.g., video, program, show, etc.) may be encoded in a multidimensional data structure (e.g., a list, an array, a vector). Assuming an image classifier capable of identifying N different objects, an N-dimensional data structure may be generated for the segment of the content asset. Each dimension of the data structure may encode a confidence score indicating a confidence of the image classifier that a corresponding object is within the segment of the content asset. The data structure may also have a dimension encoding a number of faces within the segment of the content asset, thereby resulting in an N+1 dimensional data structure.

A multidimensional data structure “segRep” may be expressed as:
segRep=[O1, O2, O3, . . . , O1000, FF], where
Oi=freq(object_i,KF_seg)/log(freq(object_i, KF_all)); freq(object_i, KF_seg): number of times the object_i appears in the segment's keyframes (i.e. KF_seg), KF_all: all keyframes accessible to the image classifier
FF=median({FF_i}) i=1,2, . . . , n; FF_i is the facial feature of the ith keyframe in the segment. n is the total number of keyframes in the segment. FF_i: number of faces+faceLoc/10̂(number of faces); faceLoc=int(str([location_k])), k=1,2, 3, . . . , number_of_faces. location_k: the hashed location of the kth face.

At step 430, a segment profile (e.g., content profile) may be determined. The segment profile may be determined from a plurality of segment profiles (e.g., by the central location 101). A segment profile may identify a segment label and a second plurality of objects typically found in a particular segment. A segment profile for an “interview” segment may identify “two” faces, and the objects “desk,” “coffee mug,” “microphone,” and/or “couch.” The objects of a particular segment may be identified as a list, or as natural language text. A segment profile may be determined based on a threshold quantity/number of objects within a segment (plurality of keyframes). Accordingly, the segment label may be determined from the plurality of segment profiles as having a highest degree of similarity (e.g., satisfying a threshold degree/quantity of similarity) between the determined first plurality of objects and the second plurality of objects identified in the segment profile. Where a segment profile is a natural language text description of the second plurality of objects, determining the segment profile may be performing natural language processing and/or keyword identification on the plurality of segment profiles to find one or more keywords corresponding to the one or more objects identifiable by the image classifier.

At step 440, metadata may then be generated that indicates an association between the segment label and the segment of the content asset (e.g., by the central location 101). The metadata may associate the segment label with the segment of the content asset, by associating the segment label with a unique identifier for the segment of the content asset, a time code of where the segment of the content asset occurs, or other identifying data. The metadata may be a manifest or other type of metadata.

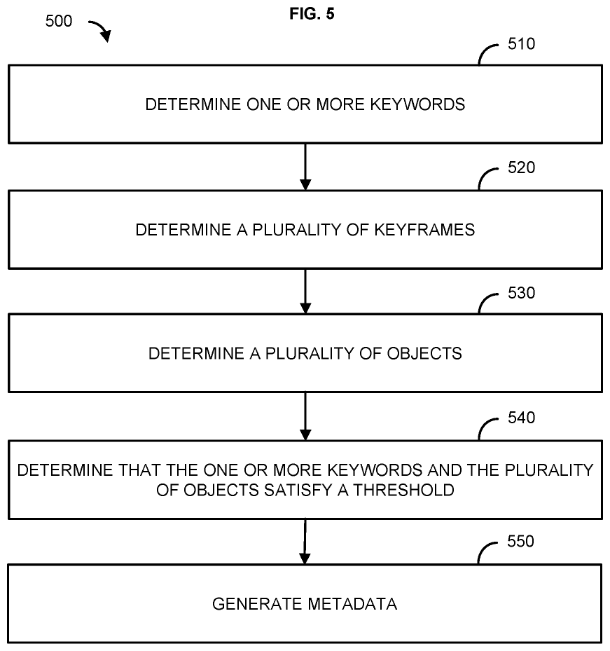

FIG. 5 is a flowchart 500 of a method. At step 510 one or more keywords in a segment profile of a plurality of segment profiles may be determined (e.g., by the central location 101). The one or more keywords may correspond to a plurality of objects identifiable by an image classifier. The image classifier may identify one or more objects of the plurality of objects in a frame of a content asset (e.g., video, program, show, etc.), such as a keyframe. The image classifier may use a machine learning model. The image classifier may also use a supervised machine learning model (e.g., a convolutional neural network (CNN), a deep neural network (DNN)) or an unsupervised machine learning model (e.g., a clustering algorithm, a general adversarial network (GAN)).

The segment profile may be a natural language description of one or more objects typically found in a segment (e.g., portion) of a content asset. A segment profile for an interview segment of a talk show may be the natural language description “one or more persons sitting at a desk and a couch.” Where the image classifier may identify the objects “desk” and “couch,” the keywords of this natural language description would be identified as “suit” and “curtain.” A segment profile for a performance segment of a talk show may be the natural language description “one or more people on a stage with microphones.” Where the image classifier may identify the objects “stage” and “microphone,” the keywords of this natural language description would be identified as “stage” and “microphone.”

At step 520, a plurality of keyframes from a segment of a content asset may be determined (e.g., generated, extracted, etc.) (e.g., by the central location 101). A keyframe may be a selected frame of the segment of the content asset. To determine the plurality of keyframes, a plurality of scenes (e.g., shots, etc.) of the segment of the content asset may be determined. A scene of the segment of the content asset (e.g., video, program, show, etc.) may be a quantity/amount of the content asset (e.g., a plurality of frames, etc.) recorded and/or rendered from a particular visual perspective (e.g., from a particular camera). A keyframe for a given scene may be determined to be and/or identified as a median frame of the scene (e.g., plurality of frames, etc.), a randomly selected frame of the scene, or otherwise determined/identified.

In some cases, each keyframe of the plurality of keyframes may be determined based on a quantity of changes between a previous frame of a plurality of frames of a segment (e.g., portion, etc.) of the content asset (e.g., video, a program, a show, etc.), a current frame of the plurality of frames, and a consecutive frame of the plurality of frames satisfying a threshold. When the quantity of changes satisfies the threshold, it may be determined that the current frame is a keyframe of the plurality of keyframes. In some cases, each keyframe of the plurality of keyframes may be determined based on an evaluation of color histograms. A color histogram may be determined for each frame of a plurality of frames of the content asset. Frames of the plurality of frames of the content asset with a color histogram of that include a distribution of color that satisfies a threshold may be a keyframe of the plurality of keyframes.

At step 530, a plurality of objects in the segment of the content asset may be determined based on the plurality of keyframes (e.g., by the central location 101). An object may be any physical object or item within a given keyframe, (e.g., a “couch,” a “table,” a “desk,” a “meatloaf,” etc.). The image classifier may be applied to a given keyframe to identify the objects within the given keyframe. The plurality of objects for a segment of the content asset may be determined as an aggregate of the one or more objects determined for each of the keyframes of the segment of the content asset. The aggregate may be an average, a median, a logarithmic function, or other aggregate function.

Identifying the plurality of objects may be achieved by filtering one or more objects from the plurality of objects. An object may be filtered from the plurality objects based on a number of keyframes in which the object appears. An object may be filtered if it appears in a number of keyframes falling below a threshold. The threshold may be a predefined threshold (e.g., two keyframes, five keyframes), a percentage of keyframes (e.g., five percent of keyframes for the segment, twenty percent of keyframes for the segment), or otherwise defined. An object may also be filtered if a confidence score for the object generated by the image classifier falls below a threshold. The one or more objects may be filtered by selecting, as the plurality of objects, N objects from the one or more objects having a highest confidence score or appearing in a highest number of keyframes.

The determined plurality of objects may be encoded in a multidimensional data structure (e.g., a list, an array, a vector). Assuming an image classifier capable of identifying N different objects, an N-dimensional data structure may be generated for a given segment. Each dimension of the data structure may encode a confidence score indicating a confidence of the image classifier that a corresponding object is part of the segment of the content asset. The data structure may also have a dimension encoding a number of faces in the segment of the content asset (e.g., as determined using a facial recognition algorithm, on the plurality of keyframes), thereby resulting in an N+1 dimensional data structure.

A multidimensional data structure “segRep” may be expressed as:
segRep=[O1, O2, O3, . . . , O1000, FF], where
Oi=freq(object_i,KF_seg)/log(freq(object_i, KF_all)); freq(object_i, KF_seg): number of times the object_i appears in the segment's keyframes (i.e. KF_seg), KF_all: all keyframes accessible to the image classifier
FF=median({FF_i}) i=1,2, . . . , n; FF_i is the facial feature of the ith keyframe in the segment. n is the total number of keyframes in the segment. FF_i: number of faces+faceLoc/10̂(number of faces); faceLoc=int(str([location_k])), k=1,2, 3, . . . , number_of_faces. location_k: the hashed location of the kth face.

At step 540 it may be determined that the determined plurality of objects and the determined plurality of keywords of the segment profile have a highest degree of similarity (e.g., satisfying a similarity threshold, etc.) relative to a remainder of the plurality of segment profiles. The degree of similarity may be a cosine similarity or another degree of similarity. The determined plurality of objects for the segment of the content asset (e.g., video, program, show, etc.) may be encoded as a multidimensional data structure. A plurality of multidimensional data structures may be generated for the plurality of segment profiles to encode the objects identified in each of the segment profiles. A multidimensional data structure may be generated for a segment profile based on the determined one or more keywords generated from a natural language description of the objects identified in a segment profile. Where the segment profiles indicate a number of faces typically occurring in a given segment, the multidimensional data structure may have an additional dimension encoding the number of faces. Accordingly, the degree of similarity may be calculated as a function of the number of faces indicated in the segment profiles and a determined number of faces for the segment of the content asset.

At step 550, metadata may then be generated that indicates an association between a segment label of the segment profile and the segment of the content asset (e.g., video, program, show, etc.). The metadata may associate the segment label with the segment of the content asset, by associating the segment label with a unique identifier for the segment of the content asset, a time code of where the segment of the content asset occurs, or other identifying data. The metadata may be a manifest or other type of metadata.

The methods and systems may be implemented on a computer 601 as shown in

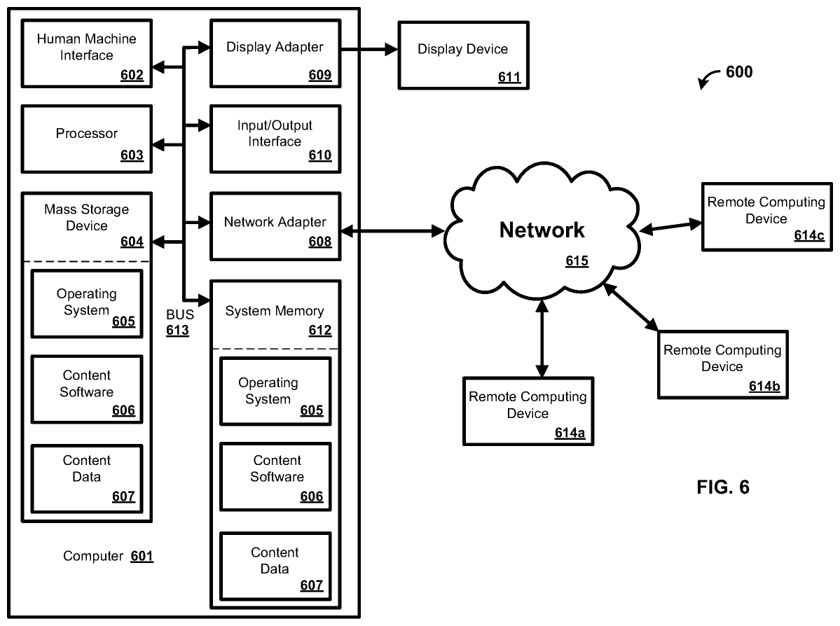

FIG. 6 and described below. The central location 101 of FIG. 1 may be one or more computers as shown in FIG. 6. Similarly, the methods and systems described may utilize one or more computers to perform one or more functions in one or more locations. FIG. 6 is a block diagram of an operating environment for performing the described methods. This operating environment is only one type of operating environment and is not intended to suggest any limitation as to the scope of use or functionality of operating environment architecture. Neither should the operating environment be interpreted as having any dependency or requirement relating to any one or combination of components shown in the operating environment.

The present methods and systems may be operational with numerous other general purpose or special purpose computing system environments or configurations. Well known computing systems, environments, and/or configurations that may be suitable for use with the systems and methods are personal computers, server computers, laptop devices, multiprocessor systems, etc. Additional computing system environments or configurations may be set top boxes, programmable consumer electronics, network PCs, minicomputers, mainframe computers, distributed computing environments using any of the above systems or devices, and the like.

The processing of the described methods and systems may be performed by software components. The described systems and methods may be described in the general context of computer-executable instructions, such as program modules, being executed by one or more computers or other devices. Generally, program modules are computer code, routines, programs, objects, components, data structures, etc. that perform particular tasks or implement particular abstract data types. The described methods may also be practiced in grid-based and distributed computing environments where tasks are performed by remote processing devices that are linked through a communications network. In a distributed computing environment, program modules may be located in both local and remote computer storage media including memory storage devices.

Further, one skilled in the art will appreciate that the systems and methods described herein may be implemented via a general-purpose computing device in the form of a computer 601. The components of the computer 601 may be, but are not limited to, one or more processors 603, a system memory 612, and a system bus 613 that couples system components including the one or more processors 603 to the system memory 612. The system may utilize parallel computing.

The system bus 613 represents one or more of several possible types of bus structures, including a memory bus or memory controller, a peripheral bus, an accelerated graphics port, or local bus using any of a variety of bus architectures. Such architectures may be an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description may also be implemented over a wired or wireless network connection and each of the subsystems, including the one or more processors 603, a mass storage device 604, an operating system 605, content software 606, content data 607, a network adapter 608, the system memory 612, an Input/Output Interface 610, a display adapter 609, a display device 611, and a human machine interface 602, may be contained within one or more remote computing devices 614a,b,c at physically separate locations, connected through buses of this form, in effect implementing a fully distributed system.

The computer 601 may have a variety of computer readable media. Exemplary readable media may be any available media that is accessible by the computer 601 such as volatile and non-volatile media, removable and non-removable media. The system memory 612 may be computer readable media in the form of volatile memory, such as random access memory (RAM), and/or non-volatile memory, such as read only memory (ROM). The system memory 612 typically contains data such as the content data 607 and/or program modules such as the operating system 605 and the content software 606 that are immediately accessible to and/or are presently operated on by the one or more processors 603.

The computer 601 may also have other removable/non-removable, volatile/non-volatile computer storage media. FIG. 6 shows the mass storage device 604 which may provide non-volatile storage of computer code, computer readable instructions, data structures, program modules, and other data for the computer 601. The mass storage device 604 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules may be stored on the mass storage device 604, including the operating system 605 and the content software 606. Each of the operating system 605 and the content software 606 (or some combination thereof) may have elements of the programming and the content software 606. The content data 607 may also be stored on the mass storage device 604. The content data 607 may be stored in any of one or more databases known in the art. Examples of such databases are DB2®, Microsoft® Access, Microsoft® SQL Server, Oracle®, mySQL, PostgreSQL, and the like. The databases may be centralized or distributed across multiple systems.

The user may enter commands and information into the computer 601 via an input device (not shown). Examples of such input devices are a keyboard, pointing device (e.g., a “mouse”), a microphone, a joystick, a scanner, tactile input devices such as gloves, and other body coverings, and the like These and other input devices may be connected to the one or more processors 603 via the human machine interface 602 that is coupled to the system bus 613, but may be connected by other interface and bus structures, such as a parallel port, game port, an IEEE 1394 Port (also known as a Firewire port), a serial port, or a universal serial bus (USB).

The display device 611 may also be connected to the system bus 613 via an interface, such as the display adapter 609. It is contemplated that the computer 601 may have more than one display adapter 609 and the computer 601 may have more than one display device 611. The display device 611 may be a monitor, an LCD (Liquid Crystal Display), or a projector. In addition to the display device 611, other output peripheral devices may be components such as speakers (not shown) and a printer (not shown) which may be connected to the computer 601 via the Input/Output Interface 610. Any step and/or result of the methods may be output in any form to an output device. Such output may be any form of visual representation, including, but not limited to, textual, graphical, animation, audio, tactile, and the like. The display device 611 and computer 601 may be part of one device, or separate devices.

The computer 601 may operate in a networked environment using logical connections to one or more remote computing devices 614a,b,c. A remote computing device may be a personal computer, portable computer, smartphone, a server, a router, a network computer, a peer device or other common network node, and so on. Logical connections between the computer 601 and a remote computing device 614a,b,c may be made via a network 615, such as a local area network (LAN) and/or a general wide area network (WAN). Such network connections may be through the network adapter 608. The network adapter 608 may be implemented in both wired and wireless environments. Such networking environments are conventional and commonplace in dwellings, offices, enterprise-wide computer networks, intranets, and the Internet.

Application programs and other executable program components such as the operating system 605 are shown herein as discrete blocks, although it is recognized that such programs and components may reside at various times in different storage components of the computing device 601, and are executed by the one or more processors 603 of the computer 601. An implementation of content software 606 may be stored on or sent across some form of computer readable media. Any of the disclosed methods may be performed by processor-executable instructions embodied on computer readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
determining, from a portion of a content asset, a plurality of keyframes;
determining, based on the plurality of keyframes, a quantity of attributes; and
determining, based on the quantity of attributes satisfying a threshold, a segment label for the portion of the content asset.

2. The method of claim 1, wherein the quantity of attributes comprises one or more of a quantity of faces associated with the plurality of keyframes, a quantity of objects associated with the plurality of keyframes, or a quantity of advertisements associated with the plurality of keyframes.

3. The method of claim 1, wherein determining the plurality of keyframes comprises:
determining, for each frame of a plurality of frames of the content asset, a color histogram of a plurality of color histograms; and
determining, based on a color histogram of the a plurality of color histograms comprising a distribution of color that satisfies a threshold, that a respective frame of the plurality of frames is a keyframe of the plurality of keyframes.

4. The method of claim 1, wherein determining the plurality of keyframes comprises determining, based on a quantity of changes between a previous frame of a plurality of frames, a current frame of the plurality of frames, and a consecutive frame of the plurality of frames satisfying a threshold, that the current frame is a keyframe of the plurality of keyframes.

5. The method of claim 1, wherein determining the quantity of attributes comprises facial recognition.

6. The method of claim 1, wherein determining the quantity of attributes comprises object identification.

7. The method of claim 6, wherein determining the segment label comprises applying, based on one or more objects identified by the object identification, an image classifier to each keyframe of the plurality of keyframes.

8. The method of claim 6, wherein determining the segment label comprises determining, based on a quantity of matches between one or more objects of a segment profile and the one or more objects identified by the object identification satisfying a threshold, the segment label.

9. The method of claim 1, wherein the quantity of attributes comprises one or more of audio content or closed caption information, wherein determining the segment label comprises determining, based on one or more of the audio content or the closed caption information, the segment label.

10. A method comprising:
determining, from a portion of a content asset, a plurality of keyframes;
determining, based on the plurality of keyframes, a first plurality of objects;
determining, based on a quantity of matches between the first plurality of objects and a second plurality of objects satisfying a threshold, a segment profile; and
generating metadata, wherein the metadata indicates an association between the segment profile and the portion of the content asset.

11. The method of claim 10, wherein determining the first plurality of objects comprises applying an image classifier to the plurality of keyframes.

12. The method of claim 10, wherein determining the first plurality of objects comprises:
determining, based on object identification, for each object of the first plurality of objects, a confidence score of a plurality of confidence scores, wherein the plurality of confidence scores indicate an association to one or more identifiable objects; and
determining that each confidence score of the plurality of confidence scores satisfies a threshold.

13. The method of claim 12, wherein determining the plurality of keyframes comprises determining, based on a quantity of changes between a previous frame of a plurality of frames, a current frame of the plurality of frames, and a consecutive frame of the plurality of frames satisfying a threshold, that the current frame is a keyframe of the plurality of keyframes.

14. The method of claim 12, wherein determining the plurality of confidence scores comprises:
generating a data structure comprising a plurality of dimensions, wherein each dimension of the plurality of dimensions corresponds to a respective identifiable object of the one or more identifiable objects; and
storing each confidence score of the plurality of confidence scores in a corresponding dimension of the plurality of dimensions.

15. The method of claim 10, further comprising:
determining, based on the plurality of keyframes and facial recognition, a quantity of faces associated with the portion of the content asset; and
determining, based on the quantity of faces, the segment profile.

16. A method comprising:
determining one or more keywords of a natural language description of a segment profile, wherein the one or more keywords are associated with a plurality of identifiable objects of an image classifier;
determining, from a portion of a content asset, a plurality of keyframes;
determining, based on the plurality of keyframes and the image classifier, a plurality of objects from the portion of the content asset;
determining that the plurality of objects and the one or more keywords of the segment profile have a degree of similarity that satisfies a threshold; and
generating metadata, wherein the metadata indicates an association between a segment label of the segment profile and the portion of the content asset.

17. The method of claim 16, wherein the metadata further indicates an association between a plurality of segment labels and a plurality of portions of the content asset, wherein the segment label of the segment profile is a segment label of the plurality of segment labels and the portion of the content asset is a portion of the plurality of portions of the content asset.

18. The method of claim 17, wherein the segment profile further indicates a quantity of faces associated with the portion of the content asset.

19. The method of claim 16, wherein determining the plurality of keyframes comprises:
determining, for each frame of a plurality of frames of the content asset, a color histogram of a plurality of color histograms; and
determining, based on a color histogram of the a plurality of color histograms comprising a distribution of color that satisfies a threshold, that a respective frame of the plurality of frames is a keyframe of the plurality of keyframes.

20. The method of claim 16, wherein determining the plurality of keyframes comprises determining, based on a quantity of changes between a previous frame of a plurality of frames, a current frame of the plurality of frames, and a consecutive frame of the plurality of frames satisfying a threshold, that the current frame is a keyframe of the plurality of keyframes.
